(19) United States
(12) Patent Application Publication
(10) Pub. No.: US 2005/0020772 A1
(43) Pub. Date: Jan. 27, 2005

(54) Antistatic styrenic polymer composition

(76) Inventors: Christophe Lacroix, Harquency (FR); Martin Baumert, Serquigny (FR)

Correspondence Address: SMITH, GAMBRELL & RUSSELL, LLP, 1850 M STREET, N.W., SUITE 800, WASHINGTON, DC, 20036, US

(21) Appl. No.: 10/502,883

(22) PCT Filed: Jan. 31, 2002
(86) PCT No.: PCT/FR02/00383

(51) Int. Cl. C08L 53/00

(52) U.S. Cl. 525/88; 525/89

(57) ABSTRACT

The invention relates to a composition comprising, for 100 parts by weight, 99-60 parts of a styrenic polymer (A), 1-40 parts of (B)+(C), (B) being a polyamide block and polyether block copolymer essentially comprising ethylene oxide patterns (C2H4-O)—, (C) being a compatibilizer chosen from block copolymers comprising at least one polymerized block comprising styrene and at elast one polymerized block comprising methyl methacrylate, (B)/(C) ranging from 2 to 10.

The present invention relates to antistatic styrenic polymer compositions and more specifically to a composition comprising a styrenic polymer (A), a copolymer (B) containing polyamide blocks and polyether blocks comprising essentially ethylene oxide units —(C₂H₄—O)—, and a compatibilizer (C).

The aim of the invention is to give the styrenic polymer (A) antistatic properties. The formation and retention of static-electricity charges on the surface of most plastics are known. The presence of static electricity on thermoplastic films results, for example, in these films sticking to one another, making them difficult to separate. The presence of static electricity on packaging films may cause the accumulation of dust on the articles to be packaged and thus impede their use. Styrenic resins, such as polystyrene or ABS, are used to make cases for computers, for telephones, for televisions, for photocopiers, and for numerous other articles. Static electricity causes accumulation of dust but most importantly can also cause damage to microprocessors or constituents of electronic circuits present in these articles. For these applications, it is generally desirable to find compositions based on styrenic resin whose surface resistivity is below 5.10¹³ Ω/□ measured to the standard IEC93 or whose volume resistivity is below 5.10¹⁶ Ω.cm measured to the standard IEC93 (the type of resistivity being chosen as a function of the application, given that these two types of resistivity always increase in the same direction) . This is based on the consideration that these resistivities provide adequate antistatic properties for certain applications in the field of polymer materials in contact with electronic components.

The prior art has described antistatic agents, such as ionic surfactants of ethoxylated amine type or sulfonate type which are added within polymers. However, the antistatic properties of the polymers depend on ambient humidity and are not permanent, since these agents migrate to the surface of the polymers and disappear. Copolymers containing hydrophilic polyether blocks and polyamide blocks have therefore been proposed as antistatic agents, these agents having the advantage of not migrating and therefore of providing antistatic properties which are permanent and less dependent on ambient humidity.

The Japanese patent application JP 60 170 646 A, published Sep. 4, 1985, describes compositions consisting of from 0.01 to 50 parts of polyether block amide and 100 parts of polystyrene, these being used to make sliding parts and wear-resistant parts. The antistatic properties are not mentioned.

Patent application EP 167 824, published Jan. 15, 1986, describes compositions similar to the preceding compositions, and according to one embodiment of the invention the polystyrene may be blended with a polystyrene functionalized by an unsaturated carboxylic anhydride. These compositions are used to make injection-molded parts. The antistatic properties are not mentioned.

The Japanese patent application JP 60 023 435 A, published Feb. 6, 1985, describes antistatic compositions comprising from 5 to 80% of polyetheresteramides and from 95 to 20% of a thermoplastic resin chosen from, inter alia, polystyrene, ABS and PMMA, this resin being functionalized by acrylic acid or maleic anhydride. The amount of polyetheresteramide in the examples is 30% by weight of the compositions.

The patent EP 242 158 describes antistatic compositions comprising from 1 to 40% of polyetheresteramide and from 99 to 60% of a thermoplastic resin chosen from styrenic resins, PPO and polycarbonate. According to a preferred embodiment, the compositions also comprise a vinyl polymer functionalized by a carboxylic acid, one example being a polystyrene modified by methacrylic acid.

The international patent application PCT/FR00/02140 teaches the use of copolymers of styrene and of an unsaturated carboxylic anhydride, copolymers of ethylene and of an unsaturated carboxylic anhydride, copolymers of ethylene and of an unsaturated epoxide, block copolymers in the form of SBS or SIS grafted with a carboxylic acid or an unsaturated carboxylic anhydride, as compatibilizer between a styrenic resin and a copolymer containing polyamide blocks and polyether blocks.

Other prior-art documents which may be cited are:
EP 927727,
J. Polym. Sci., Part C: Polym. Lett. (1989), 27(12), 481
J. Polym. Sci., Part B, Polym. Phys. (1996), 34(7), 1289
JAPS, (1995), 58(4), 753
JP 04370156
JP 04239045
JP 02014232
JP 11060855
JP 11060856
JP 09249780
JP 08239530
JP 08143780

The prior art demonstrates either blends (i) of styrenic resin and polyetheresteramide without compatibilizer or blends (ii) of polyetheresteramide and functionalized styrenic resin or else blends (iii) of polyetheresteramide, non-functionalized styrenic resin and functionalized styrenic resin.

The blends (i) are antistatic if the polyetheresteramide is carefully chosen, but have poor mechanical properties, elongation at break in particular being much lower than that of the styrenic resin alone. As far as the blends (ii) and (iii) are concerned, it is necessary to have access to a functionalized styrenic resin, and this is a complicated and costly matter. The object of the invention is to provide antistatic properties to the ordinary styrenic resins used to make the abovementioned articles, these being non-functionalized resins. It has now been found that when particular compatibilizers are used it is possible to obtain styrenic resin compositions which comprise a styrenic resin and a copolymer containing polyamide blocks and polyether blocks, and which have excellent elongation at break, excellent tensile strength and excellent impact resistance (Charpy notched), when compared with the same composition without compatibilizer.

The present invention provides a composition comprising per 100 parts by weight:
from 99 to 60 parts by weight of a styrenic polymer (A),
from 1 to 40 parts by weight of (B)+(C), (B) being a copolymer containing polyamide blocks and polyether blocks comprising essentially ethylene oxide units —(C₂H₄—O)—, and (C) being a compatibilizer chosen from block copolymers comprising at least one polymerized block comprising styrene and at least one polymerized block comprising methyl methacrylate, the (B)/(C) ratio by weight being between 2 and 10.

By way of example of styrenic polymer (A) mention may be made of polystyrene, polystyrene modified by elastomers, random or block copolymers of styrene and of dienes such as butadiene, copolymers of styrene and of acrylonitrile (SAN), SAN modified by elastomers, in particular ABS, obtained, for example, by grafting (graft polymerization) of styrene and acrylonitrile on a graft-base composed of polybutadiene or of butadiene-acrylonitrile copolymer, and blends of SAN and of ABS. The abovementioned elastomers may be, for example, EPR (abbreviation for ethylene-propylene rubber or ethylene-propylene elastomer), EPDM (abbreviation for ethylene-propylene-diene rubber or ethylene-propylene-diene elastomer), polybutadiene, acrylonitrile-butadiene copolymer, polyisoprene, isoprene-acrylo-nitrile copolymer. In particular, A may be an impact polystyrene comprising a matrix of polystyrene surrounding rubber nodules generally comprising polybutadiene.

In the abovementioned polymers (A), part of the styrene may be replaced by unsaturated monomers copolymerizable with styrene, and by way of example mention may be made of alpha-methylstyrene and the (meth)acrylic esters. In this case, A may comprise a copolymer of styrene, among which mention may be made of styrene-alpha-methylstyrene copolymers, styrene-chlorostyrene copolymers, styrene-propylene copolymers, styrene-butadiene copolymers, styrene-isoprene copolymers, styrene-vinyl chloride copolymers, styrene-vinyl acetate copolymers, styrene-alkyl acrylate copolymers (methyl acrylate, ethyl acrylate, butyl acrylate, octyl acrylate, phenyl acrylate), styrene-alkyl methacrylate copolymers (methyl methacrylate, ethyl methacrylate, butyl methacrylate, phenyl methacrylate), styrene-methyl chloroacrylate copolymers and styrene-acrylonitrile-alkyl acrylate copolymers. The content of comonomers in these polymers is generally up to 20% by weight. The present invention also provides high-melting-point metallocene polystyrenes.

Without exceeding the scope of the invention, (A) could be a blend of two or more of the preceding polymers.

The styrenic polymer A preferably comprises more than 50% by weight of styrene. If the styrenic polymer is SAN, it preferably contains more than 75% by weight of styrene.

The polymers (B) containing polyamide blocks and polyether blocks are the result of copolycondensation of terminally reactive polyamide sequences with terminally reactive polyether sequences, examples being, inter alia:
1) Polyamide sequences having diamine chain ends with polyoxyalkylene sequences having dicarboxylic chain ends.
2) Polyamide sequences having dicarboxylic chain ends with polyoxyalkylene sequences having diamine chain ends and obtained via cyanoethylation and hydrogenation of alpha-omega-dihydroxylated aliphatic polyoxyalkylene sequences known as polyetherdiols.
3) Polyamide sequences having dicarboxylic chain ends with polyetherdiols, the products obtained in this particular case being polyetheresteramides. The copolymers (B) are advantageously of this type.

The polyamide sequences having dicarboxylic chain ends derive, for example, from the condensation of alpha-omega-aminocarboxylic acids, of lactams or of dicarboxylic acids and diamines in the presence of a dicarboxylic acid as chain regulator.

The number-average molecular weight Mn of the polyamide sequences is between 300 and 15 000 and preferably between 600 and 5000. The weight Mn of the polyether sequences is between 100 and 6000 and preferably between 200 and 3000.

The polymers containing polyamide blocks and polyether blocks may also comprise units having random distribution. These polymers may be prepared via simultaneous reaction of the polyether and of the precursors of the polyamide blocks.

For example, a reaction may be carried out using polyetherdiol, a lactam (or an alpha-omega-amino acid) and a diacid chain regulator in the presence of a little water. This gives a polymer having essentially polyether blocks and polyamide blocks of very variable length, and also having the various reactants randomly distributed along the polymer chain, having reacted in random fashion.

These polymers containing polyamide blocks and polyether blocks which derive from the copolycondensation of polyamide sequences and polyethers prepared previously or from a one-step reaction have, for example, Shore D hardnesses which can be between 20 and 75 and advantageously between 30 and 70 and have intrinsic viscosity between 0.8 and 2.5 measured in meta-cresol at 250° C. for an initial concentration of 0.8 g/100 ml. The MFIs may be between 5 and 50 (235° C. under a load of 1 kg)

The polyetherdiol blocks are either used as they stand and copolycondensed with the carboxylic-terminated polyamide blocks or are aminated and then converted to polyetherdiamines and condensed with the carboxylic-terminated polyamide blocks. They may also be mixed with precursors of polyamide and a chain regulator to make polymers containing polyamide blocks and polyether blocks having randomly distributed units.

Polymers containing polyamide blocks and polyether blocks are described in the patents U.S. Pat. Nos. 4,331,786, 4,115,475, 4,195,015, 4,839,441, 4,864,014, 4,230,838 and 4,332,920.

In a first embodiment of the invention, the polyamide sequences having dicarboxylic chain ends derive, for example, from the condensation of alpha-omega-amino-carboxylic acids, of lactams or of dicarboxylic acids and diamines in the presence of a dicarboxylic acid chain regulator. By way of example of alpha-omega-aminocarboxylic acids, mention may be made of aminoundecanoic acid, and by way of example of a lactam mention may be made of caprolactam and laurolactam, and by way of example of dicarboxylic acid mention may be made of adipic acid, decanedioic acid and dodecanedioic acid, and by way of example of diamine mention may be made of hexamethylenediamine. The polyamide blocks are advantageously composed of nylon-12 or of nylon-6. The melting point of these polyamide sequences, which is also that of the copolymer (B), is generally from 10 to 15° C. below that of PA 12 or of PA 6.

Depending on the nature of (A), it can be useful to use a copolymer (B) whose melting point is less high in order to avoid degrading (A) during the incorporation of (B), and this is the subject of the second and third embodiment of the invention below.

In a second embodiment of the invention, the polyamide sequences are the result of condensation of one or more alpha-omega-aminocarboxylic acids and/or of one or more lactams having from 6 to 12 carbon atoms in the presence of a dicarboxylic acid having from 4 to 12 carbon atoms, and are of low weight, i.e. Mn from 400 to 1000. By way of example of alpha-omega-amino-carboxylic acid mention may be made of aminoundecanoic acid and aminododecanoic acid. By way of example of dicarboxylic acid mention may be made of adipic acid, sebacic acid, isophthalic acid, butanedioic acid, cyclohexane-1,4-dicarboxylic acid, terephthalic acid, the sodium or lithium salt of sulfoisophthalic acid, dimerized fatty acids (these dimerized fatty acids having a dimer content of at least 98% by weight and preferably being hydrogenated) and dodecanedioic acid HOOC—(CH₂)₁₀—COOH.

By way of example of lactam, mention may be made of caprolactam and laurolactam.

Caprolactam should be avoided unless the polyamide is purified by removing the caprolactam monomer which remains dissolved within it.

Polyamide sequences obtained via condensation of laurolactam in the presence of adipic acid or of dodecanedioic acid and having a weight \overline{Mn} of 750 have a melting point of 127-130° C.

In a third embodiment of the invention, the polyamide sequences are the result of condensation of at least one alpha-omega-aminocarboxylic acid (or one lactam), at least one diamine and at least one dicarboxylic acid. The alpha-omega-aminocarboxylic acid, the lactam and the dicarboxylic acid may be chosen from those mentioned above.

The diamine may be an aliphatic diamine having from 6 to 12 atoms, or it may be an acrylic and/or saturated cyclic diamine.

By way of examples mention may be made of hexa-methylenediamine, piperazine, 1-aminoethylpiperazine, bisaminopropylpiperazine, tetramethylenediamine, octa-methylenediamine, decamethylenediamine, dodecamethylenediamine, 1,5-diaminohexane, 2,2,4-trimethyl-1,6-diaminohexane, diamine polyols, isophoronediamine (IPD), methylpentamethylenediamine (MPDM), bis (amino-cyclohexyl)methane (BACM), bis (3-methyl-4-aminocyclohexyl)methane (BMACM).

In the second and third embodiment of the invention, the various constituents of the polyamide sequence and their proportion are chosen in order to obtain a melting point below 150° C. and advantageously between 90 and 135° C. Low-melting-point copolyamides are described in the patents U.S. Pat. No. 4,483,975, DE 3 730 504, U.S. Pat. No. 5,459,230. The same proportions of the constituents are utilized for the polyamide blocks of (B) . (B) may also be the copolymers described in U.S. Pat. No. 5,489,667.

The polyether blocks may represent from 5 to 85% by weight of (B) . The polyether blocks may contain units other than the ethylene oxide units, e.g. units of propylene oxide or of polytetrahydrofuran (which leads to polytetramethylene glycol sections within the chain). Simultaneous use may also be made of PEG blocks, i.e. blocks consisting of ethylene oxide units, PPG blocks, i.e. blocks consisting of propylene oxide units, and PTMG blocks, i.e. blocks consisting of tetramethylene glycol units, also termed polytetrahydrofuran. Use is advantageously made of PEG blocks or of blocks obtained by ethoxylation bisphenols, e.g. bisphenol A. These latter products are described in patent EP 613 919. The amount of polyether blocks in (B) is advantageously from 10 to 50% by weight of (B) and preferably from 35 to 50%.

The copolymers of the invention may be prepared by any means permitting linkage of the polyamide blocks to the polyether blocks. Essentially, two processes are used in practice, one being a two-step process and the other being a single-step process.

The two-step process consists firstly in preparing the carboxylic-terminated polyamide blocks via condensation of precursors of polyamide in the presence of a dicarboxylic acid chain regulator, and then, in a second step, in adding the polyether and a catalyst. If the precursors of polyamide are only lactams or alpha-omega-aminocarboxylic acids, a dicarboxylic acid is added. If the precursors themselves comprise a dicarboxylic acid it is used in excess with respect to the stoichiometry of the diamines. The reaction usually takes place between 180 and 300° C., preferably from 200 to 260° C., the pressure developing in the reactor being between 5 and 30 bar, and being maintained for about 2 hours. The pressure is slowly reduced to atmospheric pressure and then the excess water is distilled off, for example for one or two hours.

Once the carboxylic-terminated polyamide has been prepared, the polyether and a catalyst are then added. The polyether may be added in one or more portions, and the same applies to the catalyst. In one advantageous embodiment, the polyether is added first, and the reaction of the terminal OH groups of the polyether and of the terminal COOH groups of the polyamide begins with formation of ester bonds and elimination of water; water is removed as far as possible from the reaction mixture by distillation, and then the catalyst is introduced in order to obtain the bond between the amide blocks and the polyether blocks. This second step is carried out with stirring, preferably under a vacuum of at least 5 mm of Hg (650 Pa) at a temperature such that the reactants and the copolymers obtained are molten. By way of example, this temperature may be between 100 and 400° C. and mostly between 200 and 300° C. The reaction is followed by measuring the torque exerted by the molten polymer on the stirrer or by measuring the electrical power consumed by the stirrer. The end of the reaction is determined by the torque value or target power value. The catalyst is defined as being any material making it easier to bond the polyamide blocks to the polyether blocks via esterification. The catalyst is advantageously a derivative of a metal (M) chosen from the group formed by titanium, zirconium and hafnium.

By way of example of a derivative mention may be made of the tetraalkoxides complying with the general formula M(OR) ₄, in which M represents titanium, zirconium or hafnium and R, identical or different, indicate linear or branched alkyl radicals having from 1 to 24 carbon atoms.

Examples of the C₁-C₂₄-alkyl radicals among which the radicals R are chosen for the tetraalkoxides used as catalysts in the process according to the invention are methyl, ethyl, propyl, isopropyl, butyl, ethylhexyl, decyl, dodecyl, hexadodecyl. The preferred catalysts are the tetraalkoxides for which the radicals R, identical or different, are the C₁-C₈-alkyl radicals. Particular examples of these catalysts are Zr(OC₂H₅)₄, Zr(O-isoC₃H₇)₄, Zr(OC₄H₉)₄, Zr(OC₅H₁₁)₄, Zr(OC₆H₁₃)₄, Hf(OC₂H₅)₄, Hf(OC₄H₉)₄, Hf(O-isoC₃H₇)₄.

The catalyst used in the process according to the invention may consist solely of one or more tetraalkoxides defined above of formula M(OR)₄. It may also be formed by combining one or more of these tetraalkoxides with one or more alcoholates of alkali metals or of alkaline earth metals having the formula (R₁O)ₚY in which R₁ indicates a hydrocarbon radical, advantageously a C₁-C₂₄-alkyl radical, and preferably a C₁-C₈-alkyl radical, Y represents an alkali metal or alkaline earth metal, and p is the valency of Y. The amounts of alcoholate of alkali metal or of alkaline earth metal and of tetraalkoxides of zirconium or of hafnium that are combined to constitute the mixed catalyst may vary within wide limits. However, it is preferable to use amounts of alcoholate and of tetraalkoxides such that the molar proportion of alcoholate is approximately equal to the molar proportion of tetraalkoxide.

The proportion by weight of catalyst, i.e. of the tetraalkoxide(s) if the catalyst does not include alcoholate of alkali metal or of alkaline earth metal, or else of the entirety of the tetraalkoxide(s) and of the alcoholate(s) of alkali metal or of alkaline earth metal if the catalyst is formed by combining these two types of compound, advantageously varies from 0.01 to 5% by weight of the mixture of the dicarboxylic polyamide with the polyoxyalkylene glycol, and is preferably between 0.05 and 2% of that weight.

By way of example of other derivatives, mention may also be made of the salts of the metal (M), in particular the salts of (M) with an organic acid and the complex salts of the oxide of (M) and/or the hydroxide of (M) with an organic acid. The organic acid may advantageously be formic acid, acetic acid, propionic acid, butyric acid, valeric acid, caproic acid, caprylic acid, lauric acid, myristic acid, palmitic acid, stearic acid, oleic acid, linoleic acid, linolenic acid, cyclohexanecarboxylic acid, phenyl-acetic acid, benzoic acid, salicylic acid, oxalic acid, malonic acid, succinic acid, glutaric acid, adipic acid, maleic acid, fumaric acid, phthalic acid and crotonic acid. Acetic and propionic acids are particularly preferred. M is advantageously zirconium. These salts may be termed zirconyl salts. Without being bound by this explanation, the Applicant thinks that these salts of zirconium with an organic acid or the complex salts mentioned above release ZrO⁺⁺ during the course of the process. Use is made of the product sold as zirconyl acetate. The amount to use is the same as that for the M(OR)₄ derivatives.

This process and these catalysts are described in the patents U.S. Pat. Nos. 4,332,920, 4,230,838, 4,331,786, 4,252,920, JP 07145368A, JP 06287547A and EP 613919.

With respect to the single-step process, all the reactants used in the two-step process are mixed, i.e. the precursors of polyamide, the dicarboxylic acid chain regulator, the polyether and the catalyst. The reactants and the catalyst are the same as those in the two-step process described above. If the precursors of polyamide are only lactams, it is advantageous to add a little water.

The copolymer essentially has the same polyether blocks and the same polyamide blocks, but also has a small fraction of the various reactants randomly distributed along the polymer chain, having reacted in random fashion.

The reactor is closed and heated, with stirring, as in the first step of the two-step process described above. The pressure that develops is between 5 and 30 bar. Once the pressure increase has concluded, reduced pressure is applied to the reactor while maintaining vigorous stirring of the molten reactants. The reaction is followed as above for the two-step process.

The catalyst used in this one-step process is preferably a salt of the metal (M) with an organic acid or a complex salt of the oxide of (M) and/or the hydroxide of (M) with an organic acid.

The ingredient (B) may also be a polyetheresteramide (B) having polyamide blocks comprising sulfonates of dicarboxylic acids either as chain regulators for the polyamide block or in association with a diamine as one of the monomers constituting the polyamide block, and having polyether blocks essentially consisting of alkylene oxide units, as described in the international application PCT/FR00/02889.

The compatibilizer C may be any block copolymer comprising at least one polymerized block comprising styrene and at least one polymerized block comprising methyl methacrylate.

The polymerized block comprising styrene is generally present in C in a proportion of from 20 to 80% by weight.

The polymerized block comprising methyl methacrylate is generally present in C in a proportion of from 20 to 80% by weight.

The polymerized block comprising styrene generally has a glass transition temperature above 100° C. and preferably comprises at least 50% by weight of styrene. The polymerized block comprising styrene may also comprise an unsaturated epoxide (obtained by copolymerization), this latter preferably being glycidyl methacrylate. The unsaturated epoxide may be present in a proportion of from 0.01% to 5% by weight in the polymerized block comprising styrene.

The polymerized block comprising methyl methacrylate generally has a glass transition temperature above 100° C. and preferably comprises more than 50% by weight of methyl methacrylate. The polymerized block comprising methyl methacrylate may also comprise an unsaturated epoxide (obtained by copolymerization), this latter preferably being glycidyl methacrylate. The unsaturated epoxide may be present in a proportion of from 0.01% to 5% by weight in the polymerized block comprising methyl methacrylate.

The block copolymer comprising at least one polymerized block comprising styrene and at least one polymerized block comprising methyl methacrylate may also be grafted with an unsaturated epoxide, preferably glycidyl methacrylate.

By way of example of unsaturated epoxide, mention may be made of:
the aliphatic glycidyl esters and aliphatic glycidyl ethers, such as allyl glycidyl ether, vinyl glycidyl ether, glycidyl maleate and glycidyl itaconate, and glycidyl (meth)acrylate, and
the alicyclic glycidyl esters and alicyclic glycidyl ethers, such as 2-cyclohexene glycidyl ether, diglycidyl cylohexene-4,5-dicarboxylate, glycidyl cyclohexene-4-carboxylate, glycidyl 2-methyl-5-norbornene-2-carboxylate and diglycidyl cis-endo-bicyclo[2.2.1]-5-heptene-2,3-di-carboxylate.

In the block comprising styrene, part of the styrene may be replaced by unsaturated monomers copolymerizable with styrene, and by way of example mention may be made of alpha-methylstyrene and the (meth)acrylic esters. In this case, the block comprising styrene is a copolymer of styrene, among which mention may be made of styrene-alpha-methylstyrene copolymers, styrene-chlorostyrene copolymers, styrene-butadiene copolymers, styrene-isoprene copolymers, styrene-vinyl chloride copolymers, styrene-vinyl acetate copolymers, styrene-alkyl acrylate copolymers (methyl acrylate, ethyl acrylate, butyl acrylate, octyl acrylate, phenyl acrylate), styrene-alkyl methacrylate copolymers (methyl methacrylate, ethyl methacrylate, butyl methacrylate, phenyl methacrylate), styrene-methyl chloroacrylate copolymers and styrene-acrylonitrile-alkyl acrylate copolymers.

In particular, C may be:
a diblock copolymer comprising a block of a polymer of styrene and a block of a polymer of methyl methacrylate;
a diblock copolymer comprising a block of a polymer of styrene and a block of poly (methyl methacrylate-co-glycidyl methacrylate);
a diblock styrene polymer-methyl methacrylate polymer copolymer, said copolymer being grafted with glycidyl methacrylate;
a diblock copolymer comprising a homopolystyrene block and a homopolymethyl methacrylate block;
a diblock copolymer comprising a homopolystyrene block and a block of poly(methyl methacrylate-co-glycidyl methacrylate);
a diblock homopolystyrene-homopolymethyl meth-acrylate copolymer, said copolymer being grafted with glycidyl methacrylate;
a diblock copolymer comprising a block of polystyrene-co-glycidyl methacrylate and a block of polymethyl methacrylate;
a diblock copolymer comprising a block of polystyrene-co-glycidyl methacrylate and a block of poly (methyl methacrylate-co-glycidyl methacrylate).

C may moreover also be a triblock S-B-M copolymer, S representing the polymerized block comprising styrene, M representing the polymerized block comprising methyl methacrylate, and B representing an elastomeric block having a glass transition temperature (Tg) below 5° C., preferably below 0° C. and more preferably below −40° C. The monomer used to synthesize the elastomeric block B may be a diene chosen from butadiene, isoprene, 2,3-dimethyl-1,3-butadiene, 1,3-pentadiene, 2-phenyl-1,3-butadiene. B is advantageously chosen from the poly(dienes), in particular poly(butadiene), poly(isoprene) and their random copolymers, or else from the partially or completely hydrogenated poly(dienes). Among the polybutadienes, it is advantageous to use those whose Tg is lowest, e.g. 1,4-polybutadiene with Tg (about −90° C.) lower than that of 1,2-polybutadiene (about 0° C.). The blocks B may also be hydrogenated. This hydrogenation is carried out by the usual methods.

The monomer used to synthesize the elastomeric block B may also be an alkyl (meth)acrylate, giving the following Tg values in brackets following the name of the acrylate: ethyl acrylate (−24° C.), butyl acrylate (−54° C.), 2-ethylhexyl acrylate (−85° C.), hydroxyethyl acrylate (−15° C.) and 2-ethylhexyl methacrylate (−10° C.). Butyl acrylate is advantageously used.

The blocks B preferably consist mainly of 1,4-poly-butadiene.

C may therefore be:
an S-B-M triblock copolymer in which S is a block of a polymer of styrene, B is a block of polybutadiene, and M is a block of a polymer of methyl methacrylate;
an S-B-M triblock copolymer in which S is a block of homopolystyrene, B is a block of polybutadiene, and M is a block of homopolymethyl methacrylate.

Within the scope of the invention is it possible to use one or more compatibilizers C.

The compatibilizer C may in particular be prepared by controlled free-radical polymerization methods in the presence of a stable free radical (generally a nitroxide) following the principle of the teaching of EP 927727. The SBMs may be obtained by an anionic route.

The level of antistatic properties increases with the proportion of (B) and, for equal amounts of (B), with the proportion of ethylene oxide units present in (B).

According to the application, preference will be given to including a proportion of (B) sufficient to obtain, in the final composition, a surface resistivity below 5.10¹³ Ω/□ measured to the standard IEC93. According to the application, preference will be given to including a proportion of (B) sufficient to give the final composition a volume resistivity below 5.10¹⁶ Ω.cm measured to the standard IEC93.

The amount of (B)+(C) is advantageously from 5 to 30 parts per 95-70 parts of (A) and preferably from 10 to 20 per 90-80 parts of (A). The (B)/(C) ratio is advantageously between 4 and 10. The amount of C in the composition may be from 0.5 to 5 parts by weight per 100 parts by weight of composition.

Within the scope of the invention it is possible to add mineral fillers (talc, CaCO₃, kaolin, etc.), reinforcing agents (glass fiber, mineral fiber, carbon fiber, etc.), stabilizers (heat, UV), flame retardants and colorants.

The compositions of the invention are prepared by the methods usual for thermoplastics, e.g. by extrusion or with the aid of twin-screw mixers.

The present invention also provides the articles manufactured with the preceding compositions; examples of these are films, pipes, sheets, packaging, cases for computers, for fax machines or for telephones.

The following abbreviations are used in the examples below:
GMA: glycidyl methacrylate;
MAM: methyl methacrylate;
SM: polystyrene-block-polymethyl methacrylate;
SM/GMA: polystyrene-block-polymethyl methacrylate grafted/copolymerized with glycidyl methacrylate;
PEG: polyethylene glycol;
PMMA: polymethyl methacrylate;
Mw: weight-average molecular weight;
Mn: number-average molecular weight;
Mw/Mn: polydispersity
Rv: volume resistivity (Ω.cm)
Rs: surface resistivity (Ω/□)
HO-TEMPO: 4-hydroxy-2,2,6,6-tetramethyl-1-piperidinyloxy usually marketed as 4-hydroxy TEMPO;
SEC: steric exclusion chromatography;
LAC: liquid adsorption chromatography;
GPC: gel permeation chromatography;
NMR: nuclear magnetic resonance;
TEM: transmission electron microscopy.

The following ingredients are used in the examples below:
PS 4241: styrene-butadiene copolymer. This copolymer has a flow index of between 3 and 5 g/10 min at 200° C. under 5 kg (standard ISO 1133:91). It is also characterized by a Vicat point of 97° C. (standard ISO 306A50). This copolymer has a styrene content of about 95% by weight. This copolymer is marketed by ATOFINA with the trademark Lacqrene.
MH1657: copolyether-block-amide having nylon-6 blocks of number-average molecular weight 1500 and PEG blocks of number-average molecular weight 1500; the melting point is 204° C. This copolymer is marketed by ATOFINA with the trademark Pebax MH1657.
SM: this is a polystyrene-block-(polymethyl methacrylate) block copolymer prepared by controlled free-radical polymerization, with Mw=106 000 and polydispersity of 2.1. The proportion of styrene is 61% by weight.
SM/GMA: this is a polystyrene-block-(methyl methacrylate-co-glycidyl methacrylate) block copolymer prepared by controlled free-radical polymerization, with Mw=108 700 and polydispersity of 2.0. The proportion of styrene is 65% by weight, and it contains 0.4% by weight of GMA.

The following characterization methods were used in the examples below:

Mechanical Properties:

The compositions obtained are injection-molded at temperatures of from 220 to 240° C. in the form of dumbbells, bars or plaques. The dumbbells permit the ISO R527 tensile tests to be carried out and the bars are used for the Charpy notched impact to the standard ISO 179:93 leA.

Antistatic Properties:

Plaques of the following dimensions 100×100 ×2 mm³ are injection-molded and permit the IEC-93 resistivity measurement tests to be carried out.

The tables give the volume resistivity measured in ohm.cm, the surface resistivity measured in ohm/□; the tensile properties obtained are also given.

All the tests are carried out at 23° C. The plaques are conditioned at 50% humidity for 15 days before testing to measure surface resistivity.

### EXAMPLES 1-6

a) Preparation of Compatibilizers C (Description of Operating Methods for the Synthesis of SM and SM/GMA)

Two jacketed steel reactors are used in cascade. The reactors are connected by lagged pipework wrapped with trace-heating cable, avoiding any cooling during flow.

The styrene, the solvent, the initiator and the OH-TEMPO (a member of the nitroxide family) are introduced into the reactor at atmospheric pressure, then heated to 140° C. A kinetic study is carried out on the reaction mixture, and for this reason samples are taken from the juncture when the temperature of the reaction mixture reaches about 130° C. All these samples are flash-evaporated (at 170° C. in an evacuated bell jar) to determine the degree of conversion of styrene into polystyrene. After about 60-70% of conversion into polystyrene, the preheated methyl methacrylate is added, in one single addition, to the upper reactor at 100° C.

The reaction mixture is brought to about 140° C. during a period of approximately 3 hours, and then subjected to devolatilization so as to remove the volatile species. The copolymer is recovered in granule form.

The table below shows the amounts of reactants employed in the first step of the synthesis for these two experiments.

| | Synthesis of a | Synthesis of a |
|---|---|---|
| | polystyrene-b- | polystyrene-b- |
| | PMMA | (PMMAgGMA) |
| Ingredients used | (SM) | (SM/GMA) |
| Styrene in g | 2850 | 2850 |
| Ethylbenzene in g | 500 | 500 |
| HO-TEMPO in g | 3.51 | 3.51 |
| Dicumyl peroxide in g | 5.61 | 5.61 |
| Methyl methacrylate in g | 6650 | 6555 |
| Glycidyl methacrylate | 0 | 95 |
| in g | | |
| Styrene polymerization | 120 | 150 |
| time in min | | |
| Copolymerization time in | 150 | 150 |
| min | | |

Experimental Conditions:

Oil bath temperature: 160° C., condenser temperature: −20° C. The zero point for the time for styrene conversion is chosen when the temperature of the polymerization mixture reaches 130° C.

The amount of MAM (or MAM/GMA mixture) is preheated to boiling before being added to the reaction mixture. The oil bath temperature is kept constant at 160° C. The condenser valve is in the closed position. The temperature becomes stable at 120° C. with an increase in the pressure in the reactor (P=1.5 bar) . The product is then recovered in granule form. The product is analyzed by LAC, GPC and NMR and also by TEM once a film has been obtained by slow evaporation in chloroform.

Supplementing these SEC analyses, quantitative LAC analyses were carried out. Using this method, it was then possible to quantify the proportions of homopolystyrene and of homoPMMA present in the reaction mixture, then to determine the composition by weight of the copolymers in terms of polystyrene and PMMA. Finally, an NMR analysis of the reaction mixture also allowed us to determine the proportions of MMM, SMS and MMS triad, representative of a block copolymer or a random copolymer (MMM=three adjacent MAM units, SMS=styrene unit followed by MAM, followed by S, and MMS=MAM unit followed by MAM, followed by styrene) . The determination of this proportion allows the degree of structuring of the block copolymer to be characterized. A percentage of 100% of MMM triad indicates complete structuring.

All of the results are shown in the table below:

| | SM | SM/GMA |
|---|---|---|
| Mw (g/mol) | 106 000 | 108 700 |
| Mw/Mn | 2.1 | 2 |
| % PS gross (by weight) | 61 | 65 |
| % GMA | 0 | 0.4 |
| % by weight of homopolystyrene | 29 | 30 |
| % by weight of copolymer | 71 | 70 |
| Average composition of PS/PMMA | 45/55 | |
| copolymer | | |
| % MMM triad | 74 | |

All of these results show that the products obtained are rich in block copolymers, since, simultaneously, the proportion of homopolystyrene is close to 30%, there is no PMMA homopolymer and finally the proportion of MMM triad is above 70%. Furthermore, the TEM analyses of these produces show lamellar structures. Irrespective of the experiment, the structure obtained is always of lamellar type throughout its volume. It may be noted that the polystyrene lamellae are distended by homopolystyrene, since the thicknesses of these lamellae are greater than those of PMMA, although the composition of the copolymer is of the order of 50/50.

The polystyrene-block-PMMA block copolymer has a styrene content of 45% by weight and a MAM content of 55% by weight.

b) Preparation of Compositions by Mixing in an Extruder.

A twin-screw Werner and Pfleiderer extruder of 30 mm diameter is used, with a total throughput rate of 20 kg/h. This throughput rate represents the total of the throughput rates for the ingredients used. The temperature settings for the barrels are from 230 to 250° C. The strands discharged from the machine are cooled in a water tank and granulated. These granules are injection-molded to give plaques, bars or dumb-bells, at similar temperatures (230-250° C.).

The results reported in the table above demonstrate the compatibilizing action of the SM and SM/GMA block copolymers. The block copolymers were used as obtained without separation from the homopolystyrene which was mixed with them. This homopolystyrene may be considered as a styrenic resin (A). In the table of results below, the amounts of SM and SM/GMA indicated correspond to undiluted amounts of copolymer. The amounts of homopolystyrene introduced during the addition of block copolymer are reported in the second row of the table.

| Example No. | 1 | 2 | 3 | 4 | 5 | 6 |
|---|---|---|---|---|---|---|
| PS 4241 | 100 | 90 | 88 | 88 | 86 | 86 |
| Homopoly- | | | 0.6 | 0.6 | 1.2 | 1.2 |
| styrene | | | | | | |
| MH 1657 | | 10 | 10 | 10 | 10 | 10 |
| Poly- | | | 1.4 | | 2.8 | |
| styrene-b- | | | | | | |
| PMMA | | | | | | |
| Poly- | | | | 1.4 | | 2.8 |
| styrene-b- | | | | | | |
| (PMMAgGMA) | | | | | | |
| Rv Ω · cm | 1.40E+17 | 8.20E+13 | 2.50E+15 | 2.60E+15 | 2.50E+16 | 2.60E+15 |
| Rs Ω/□ | 2.30E+15 | 1.10E+12 | 3.70E+12 | 3.00E+12 | 1.10E+13 | 3.90E+12 |

Charpy notched ISO 179:93 1eA

| | | | | | | |
|---|---|---|---|---|---|---|
| +23° C. kJ/m² | 11.1 | 7.1 | 8.6 | 11.1 | 10.9 | 11.1 |

Tensile fracture 23° C. ISO 527:93-1B, v = 50 mm/min

| | | | | | | |
|---|---|---|---|---|---|---|
| Sigma yield | 27.4 | 24.4 | 25 | 25.5 | 25.8 | 26 |
| (MPa) | | | | | | |
| % yield | 1.4 | 1.5 | 1.4 | 1.5 | 1.5 | 1.5 |
| Sigma | 22.7 | 17 | 19.4 | 21.9 | 22.1 | 22.4 |
| fracture | | | | | | |
| (MPa) | | | | | | |
| % fracture | 56.3 | 24.2 | 36.5 | 54.6 | 55.5 | 59 |

As can be seen, elongation at break and tensile strength are improved, while the impact properties of the matrix are retained and the composition is rendered antistatic.

The influence of the block copolymers is also visible at the particle size level. For experiment 1, the size of the particles is of the order of 1 μm, whereas for examples 5 and 6 it is reduced by half (0.5 μm). The reduction in the size of the particles is generally accompanied by an improvement in the compatibilizing action of the block copolymer.

1. A composition comprising, per 100 parts by weight:
from 99 to 60 parts by weight of a styrenic polymer (A),
from 1 to 40 parts by weight of (B)+(C),
(B) being a copolymer containing polyamide blocks and polyether blocks comprising ethylene oxide units —(C₂H₄—O)—, and (C) being a compatibilizer selected from block copolymers comprising at least one polymerized block comprising styrene and at least one polymerized block comprising methyl methacrylate, the (B)/(C) ratio by weight being between 2 and 10.

2. The composition as claimed in claim 1 wherein the proportion of (B) is sufficient to give the final composition a surface resistivity below 5.10¹³ Ω/□ measured to the standard IEC93.

3. The composition as claimed in claim 1 wherein the proportion of (B) is sufficient to give the final composition a volume resistivity below 5.10¹⁶ Ω.cm measured to the standard IEC93.

4. The composition according to claim 1, wherein (A) comprises more than 50% of styrene.

5. The composition as claimed in claim 1, wherein the amount of (C) is from 0.5 to 5 parts by weight in 100 parts by weight of composition.

6. The composition as claimed in claim 1, wherein the polymerized block comprising styrene is present in C in a proportion of from 20 to 80% by weight.

7. The composition as claimed in claim 1, wherein the polymerized block comprising methyl methacrylate is present in C in a proportion of from 20 to 80% by weight.

8. The composition as claimed in claim 1, wherein the polymerized block comprising styrene comprises at least 50% by weight of styrene.

9. The composition as claimed in claim 1, wherein the polymerized block comprising styrene comprises glycidyl methacrylate.

10. The composition as claimed in claim 1, wherein the polymerized block comprising methyl methacrylate comprises more than 50% by weight of methyl methacrylate.

11. The composition as claimed in claim 1, wherein the polymerized block comprising methyl methacrylate comprises glycidyl methacrylate.

12. The composition as claimed in claim 1, wherein the block copolymer comprises at least one polymerized block comprising styrene and at least one polymerized block comprising methyl methacrylate being grafted with glycidyl methacrylate.

13. The composition as claimed in claim 1, wherein (A) is a styrene-butadiene copolymer.

14. The composition as claimed in claim 1, wherein the amount of (B)+(C) is from 5 to 30 parts per 95-70 parts of (A).

15. The composition as claimed in claim 1, wherein the amount of (B)+(C) is from 10 to 20 per 90-80 parts of (A).

16. The composition as claimed in claim 1, wherein (C) is an S-B-M triblock copolymer, S representing the polymerized block comprising styrene, M representing the polymerized block comprising methyl methacrylate, and B representing an elastomeric block having a glass transition temperature (Tg) below 5° C.

17. An article manufactured from a composition as claimed in claim 1.

18. A method for manufacturing electronic components comprising utilizing the composition of claim 1.
